(19) United States
(12) Patent Application Publication
(10) Pub. No.: US 2019/0294992 A1
(43) Pub. Date: Sep. 26, 2019

(54) HYBRID LEARNING FOR INTELLIGENT INSTRUMENTS

(71) Applicant: Yudong Zhu, Scarsdale, NY (US)

(72) Inventor: Yudong Zhu, Scarsdale, NY (US)

(21) Appl. No.: 16/203,610

(22) Filed: Nov. 29, 2018

Related U.S. Application Data
(60) Provisional application No. 62/591,253, filed on Nov. 28, 2017.

(51) Int. Cl. G06N 20/00; G06N 5/04

(52) U.S. Cl. CPC G06N 20/00; G06N 5/04

(57) ABSTRACT

Numerous instruments make inferences by fitting sensor data to knowledge that characterizes the physical world, where the knowledge result from human learning. The present intelligent instruments integrate machine learning elements with human learning elements so that they work in a hybrid fashion to improve the performance of inference making. In some embodiments human learning elements, e.g., scientific models, participate directly in the construction of some of the machine learning elements. In some embodiments machine learning elements help assess and drive the refinement of the inferences. The integration comprises training data synthesis, loss and gradient calculations, and autonomous adaptation.

This application claims the benefit of PPA Application Number 62591253 filed 28 Nov. 2017 by the present inventor, which is incorporated by reference.

### BRIEF DESCRIPTION OF THE DRAWINGS

FIG. 1 illustrates utilization, in accordance with aspects of the present invention, of both human learning and machine learning on an intelligent instrument.

FIG. 2A-2B illustrate utilization, in accordance with aspects of the present invention, of both human learning and machine learning on an intelligent instrument.

FIG. 3A-3D illustrate variants of practicing hybrid learning.

FIG. 4A-4C illustrate various techniques for defining and quantifying loss.

FIG. 5 illustrates an example of integrating Bloch equation and physics-based modeling, as applicable to parallel receive MRI, into machine learning.

FIG. 6A-6C illustrate an example of integrating Bloch equation and physics-based modeling, as applicable to MRI, with a structure model obtained from machine learning.

FIG. 7 illustrates an example of practicing hybrid learning in a multi-parameter and multi-configuration MR imaging setting.

FIG. 8 is a schematic block diagram of a magnetic resonance imaging system for use with the present invention.

### DETAILED DESCRIPTION

Numerous instruments function by essentially carrying out experiments and fitting sensor data to scientific models. Developers of such instruments typically task themselves to deploy sensors for signal detection, to design procedures for systematic collection of signals, to devise algorithms for inference or reconstruction of unknown quantities of interest with the collected signal data and applicable scientific models, and to present the inference or reconstruction results in easy-to-interpret formats.

Medical imaging equipment is a good example. A CT or MRI scanner for instance, uses sensors carefully configured near a scanned target to detect signals containing diagnostic information, uses developer-crafted measurement procedures or sequences to collect signal data, and uses developer-crafted algorithms to reconstruct quantities of diagnostic value based on the collected data and such established models as attenuation model and Bloch equation, and finally presents results in an image format for radiologists to read.

Inspired by recent achievements in the machine learning field, we propose intelligent instruments with human knowledge (which include scientific models and problem solving experiences) making one part of the core, but with machine learning elements replacing many of the other human design/devise elements (which include, e.g., development or deployment of algorithms, procedures and sensors, as well as interpretation of results) making the other part. Further, the machine learning part is optionally set to evolve or optimize continuously, leveraging features continuously learned from data throughout the use cycle of the instruments.

The intelligent instruments are hybrid learning machines—they function by utilizing both human learning and machine learning. While the former often excels in modeling with elegance and depth the operation principles of the physical world, the latter is becoming increasingly powerful spotting patterns in high-dimensional space and in massive data, and responding with solution strategies autonomously. On the new instruments the two learning paradigms work together, creating unprecedented capabilities.

In this hybrid fashion, an example embodiment employs the human established models/experiences to guide the set-up of an adaptive compute unit (ACU) for carrying out machine learning, and employs data samples to guide the adaptation or optimization of the ACU and even the experimental configurations. The experimental configurations may include sensor, procedure or sequence parameters. The ACU may be a neural network whose weights are to be optimized in training in accordance with data samples and proper loss metrics. The optimization of the ACU and/or the experimental parameters can use gradient descent and gradient back propagation techniques, and benefit from the often differentiable scientific models.

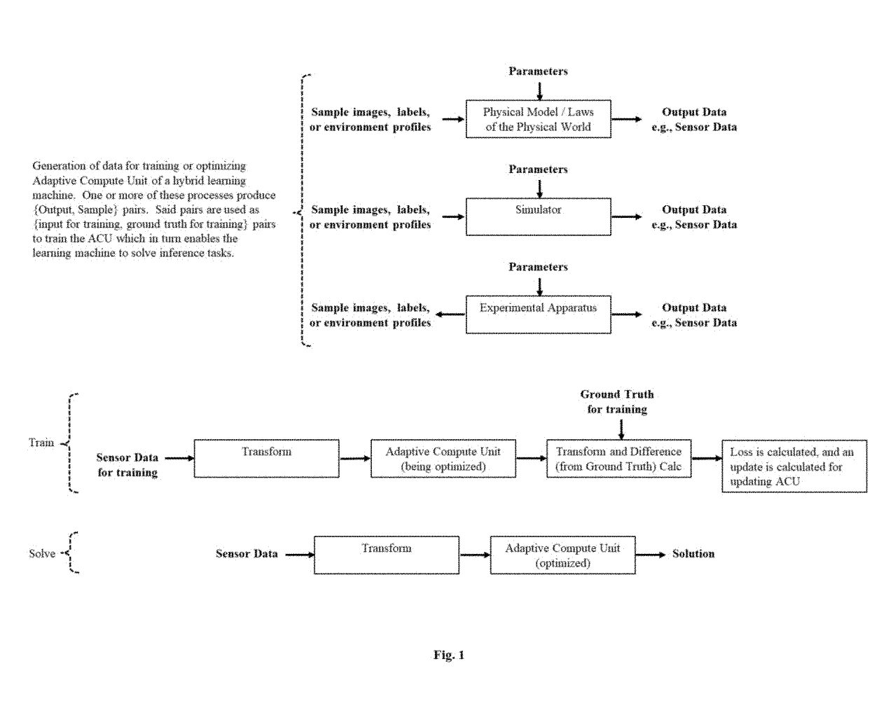

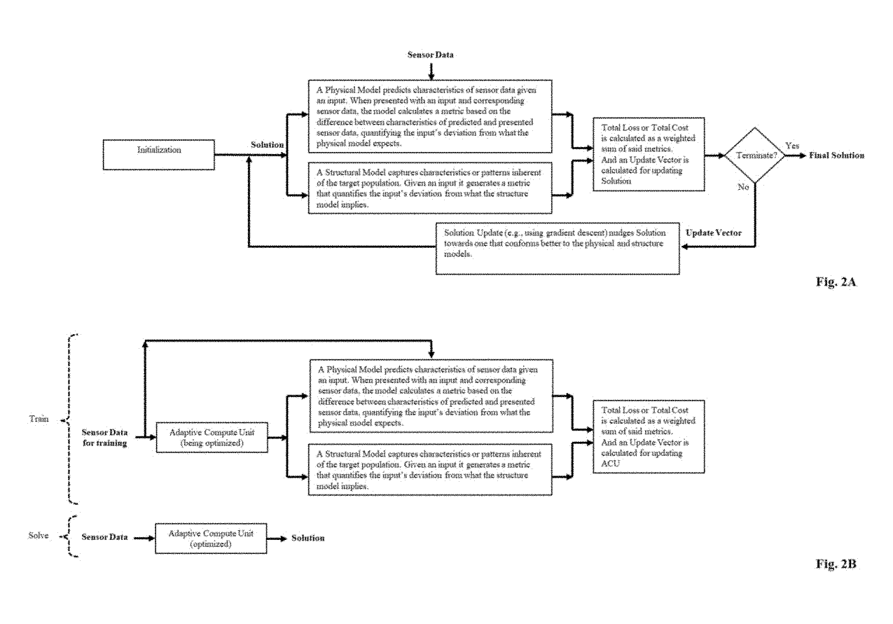

Two further embodiments are illustrated in FIGS. 1 and 2.

Hybrid learning machine solves inference problems by applying both human learning and machine learning. As results of human learning, laws of the physical world, high quality simulations and designed experiments, for example, are often good at quantifying or summarizing behaviors of interest. One can instill or integrate them into a machine learning paradigm to enhance the quality and speed of training/optimizing an ACU, and to facilitate the creation of an autonomous problem solving machine. FIG. 1 illustration exemplifies, for example, medical imaging, where the task is to infer an image or a series of images based on sensor data. There are two phases involved—the train phase that sets up the inference pipeline and the solve phase that performs the inference in an actual instance. TOP: In generating data required by the training phase, one may use one or more of several processes. The processes generate data for training by leveraging human learning results. Sample images or labels in this case are extracted from existing images or studies of actual objects. For example, the sample images or labels are derived from available image collections or PACS systems, synthesized by computation means, or produced through designed experiments. Applying laws of the physical world, high quality simulations or designed experiments, with certain parameters and environment configurations, quantifies/produces sensor responses. The resulting training data reflect both the human learning results and the statistical pattern or distribution of the target population (e.g. a manifold). Data for training are optionally generated by a more conventional process, which, in comparison, could be burdensome and less effective. Middle and Bottom: The generated training data are, for example, used as {Sensor Data, Ground Truth} pairs to train an ACU, effecting exploitation of human learning results. Upon completion the trained ACU is deployed for use, where it solves an inference task by producing image(s)/label(s) in one pass using sensor data that are acquired in an actual instance.

Hybrid learning machine solves inference problems by applying both human learning and machine learning. FIG. 2 illustration exemplifies an approach of finding a solution by balancing outcome's conformation to both human learning results (e.g., laws of the physical world or high quality simulations) and separate machine learning results (e.g., an auto-encoder or discriminator that judges conformity with established statistical patterns or distributions). The usual requirement of having access to quality ground truth data is removed. The structural model, implemented for example with a dedicated neural network, is established/trained in a separate process that has access to samples from a population of a same statistical pattern or distribution, but not necessarily involved in the present development. Sub-figures illustrate function modules and data flows in examples where an iterative technique (A) or a train-and-solve technique (B) is used. In this embodiment, with access to an ever increasing amount of samples locally or from an independent source as time goes by, the machine can periodically update/retrain the structural model itself to improve its effectiveness, effecting an autonomous self-improving mechanism.

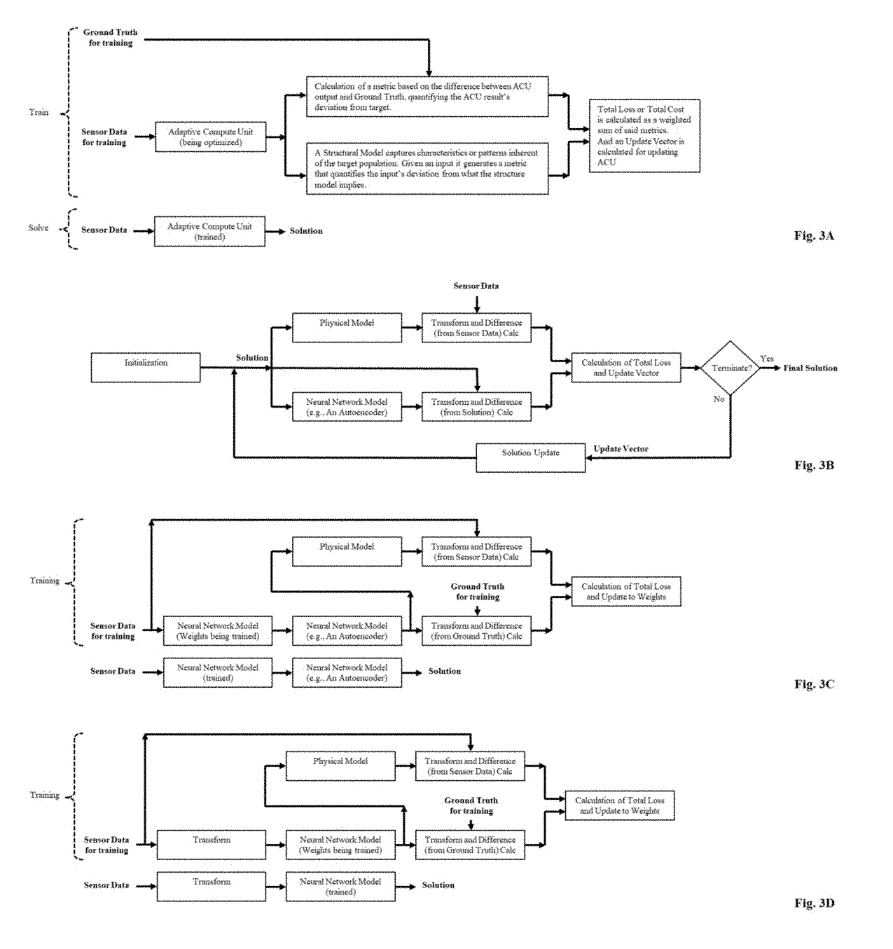

Variants or more specialized versions of the above embodiments are illustrated in FIGS. 3A-3D. FIG. 3A Train-and-solve: an ACU is built based on end-to-end training, and then deployed to generate solution in one pass. FIG. 3B Iteratively solve: starting with an initial guess, a solution is iteratively refined until a termination criteria is met. Also note the option of building and perfecting the Neural Network Model using only modality-specific quality images, independent of other models and considerations. FIG. 3C Train-and-solve: a neural network model is built based on end-to-end training, and then deployed to generate solution in one pass. FIG. 3D Train-and-solve: a neural network model is built based on end-to-end training, and then deployed to generate solution in one pass.

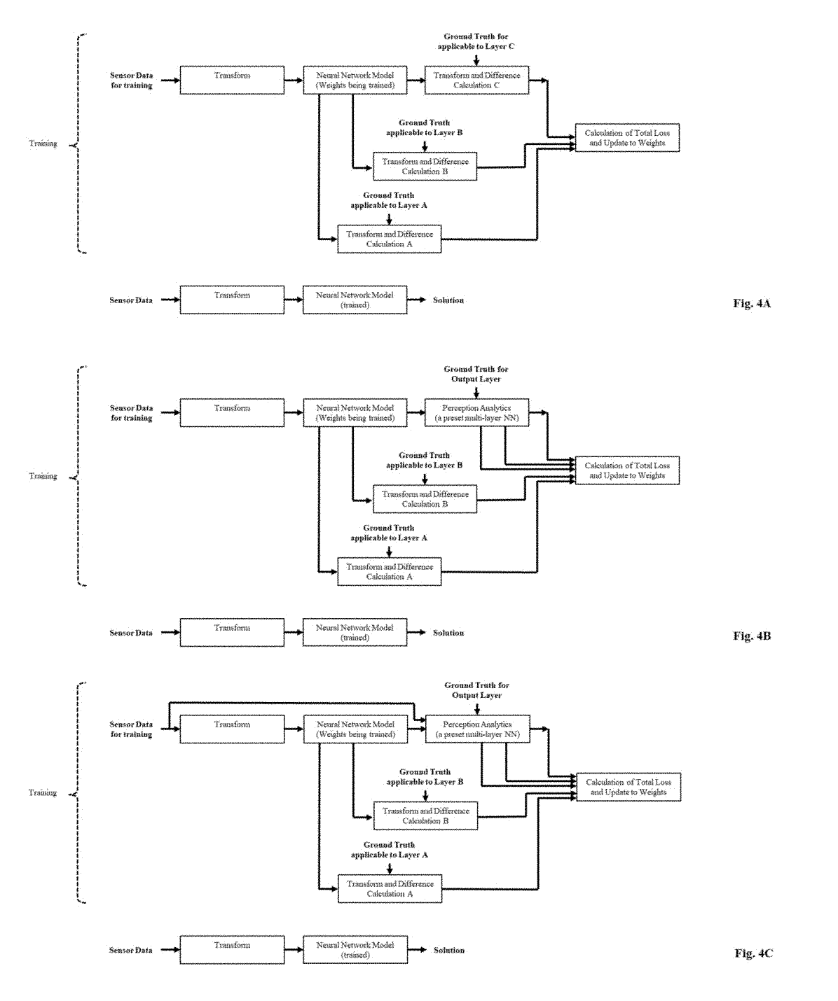

Loss quantification provides the driving force for the adaptation or optimization of the ACU, and its definition directly influences the outcomes' quality as well as the optimization landscape. FIGS. 4A-4C illustrate various techniques for defining and quantifying (total) loss, including (A) checking intermediate-layer outcomes in addition to the last-layer outcome of the neural network being trained, (B) using a dedicated discerning neural network to strengthen visual quality assessment and improvement, and (C) incorporating an element that expands discerning power with a direct, physics-based modeling of the sensor data (e.g., inter-channel signal correlation in parallel receive MRI).

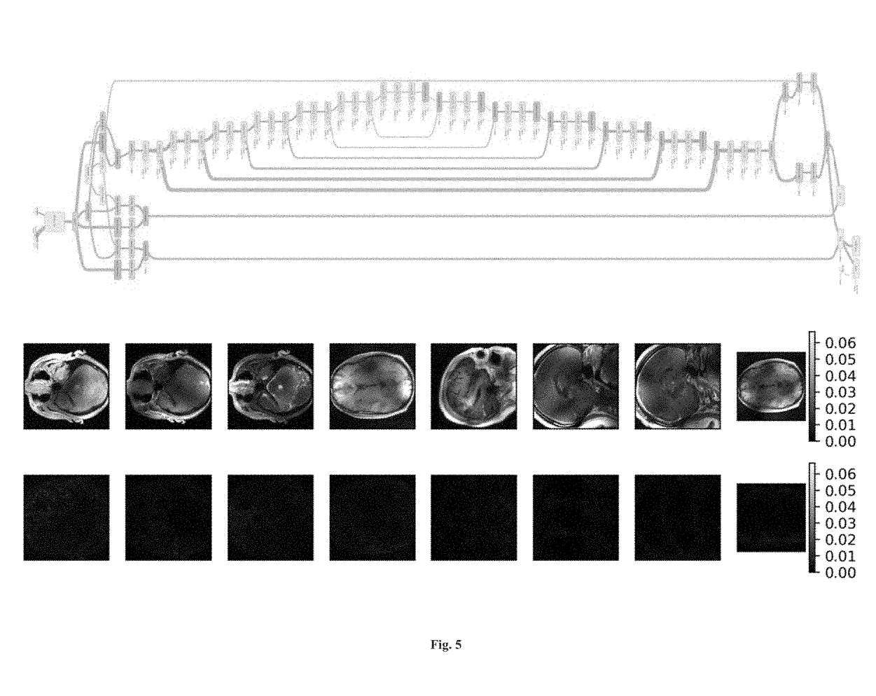

One embodiment furthering that illustrated in FIG. 1 is illustrated in FIG. 5. It includes integration into machine learning, Bloch equation and physics-based modeling applicable to parallel receive MRI. It uses TensorFlow for implementing a deep convolutional neural network and a FIG. 1-type train-and-solve technique. In the solve phase of 8 example cases, when presented with parallel receive signal data that correspond to various random or even 3x down-sampling of k-space and various multi-channel receive sensitivity profiles, the trained network reconstructed images (mid row) that are in good agreement with results from full Nyquist-rate k-space sampling and standard root sum-of-squares reconstruction (differences shown in bottom row).

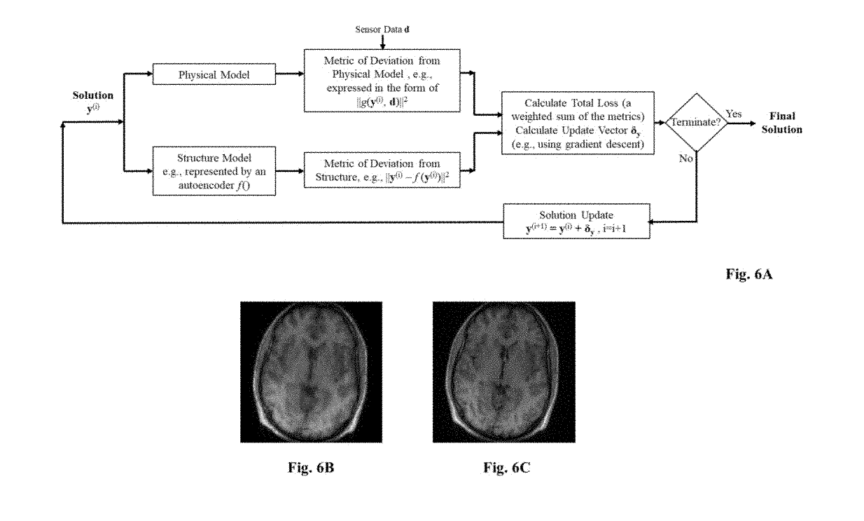

One embodiment furthering that illustrated in FIG. 2A is illustrated in FIG. 6. It includes integration with machine learning, Bloch equation and physics-based modeling applicable to MRI. It employs an iterative scheme and finds a solution by balancing outcome's conformation to both laws of the physical world (Bloch equation and physics-based modeling) and a structure model that identifies outcome's statistical patterns or distributions. The structure model is an auto-encoder in one implementation, and the auto-encoder, based on a GAN-type neural network, is independently trained with MR images collected from a variety of sources. FIG. 6C shows an example outcome of applying the present scheme in an MR scan, where neither the human subject nor the MR scanner was involved in the establishment of the structure model. At a relatively high scan acceleration in this case—6-fold acceleration in 8-channel parallel receive MRI—the present scheme significantly outperformed a compressed sensing-based scheme (result shown in FIG. 6B), demonstrating a potential for driving MRI performance beyond the state-of-the-art.

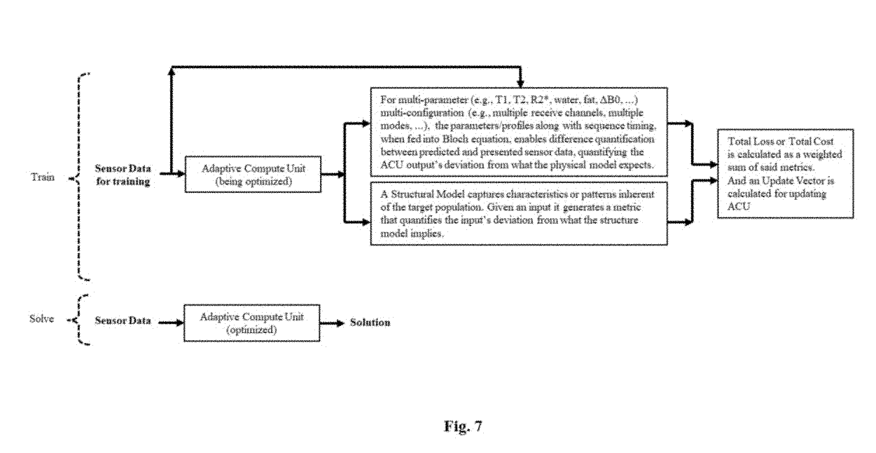

FIG. 7 illustrates an embodiment furthering FIG. 2B-type embodiment in a multi-parameter and multi-configuration MR imaging setting. Notice that FIG. 1-type embodiment can be tailored to handle multi-parameter multi-configuration MRI too, where the model- or simulator-based processes can be very effective, with sample images including T1, T2, proton density and off-resonance maps, and with environmental profiles including RF and static field profiles. An example multi-parameter multi-configuration MRI scenario is water-fat separation in MRI. Dixon's model, derived from Bloch equation model, relates sensed multi-echo signals(s) to water and fat images (ρ_{W} and ρ_{F}) as follows

s(r,tₙ)=(ρ_{W}(r)+ρ_{F}(r)e^{j2πf}^{_{F}}^{t}^{ₙ})e^{-R*}^{₂}^{(r)t}^{ₙ}^{+j2πΔB}^{ₒ}^{(r)t}^{ₙ}

where tₙ, n=1, 2, 3, . . . denotes a string of echo time (TE) shifts, r denotes voxel location, f_{F} denotes frequency shift (in Hz) of fat relative to water, ΔB₀ is local frequency shift (in Hz) due to static field inhomogeneity, and R₂* represents T2* effect.

There are explicitly controllable parameters in experiments, including, in MRI for example, sequence timing, RF excitation strength, gradient trajectories, receive coil configuration and etc. By adding to the total loss optimization an additional target such as SNR and imaging speed, the hybrid learning machine can use techniques including gradient descent and gradient back propagation to further optimize these controllable parameters and to achieve performance gains, leveraging, in a unique way, both models established for the physical world and patterns identified in high-dimensional space and in massive data.

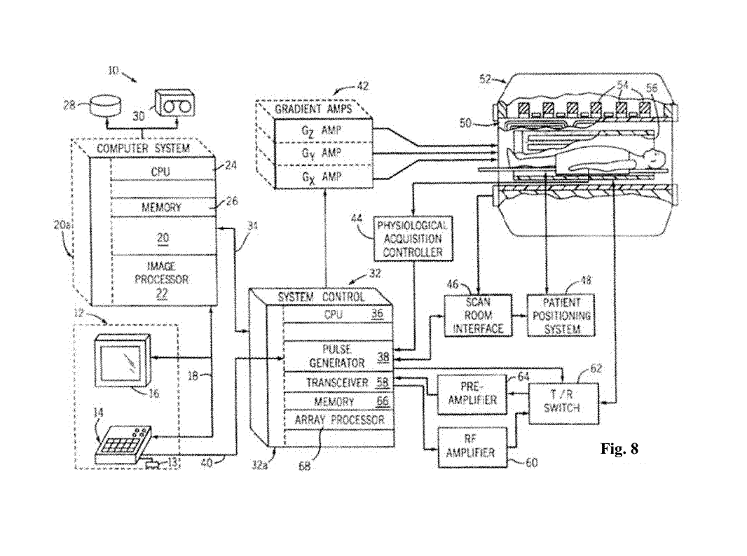

Referring to FIG. 8, the major components of an example magnetic resonance imaging (MRI) system 10 incorporating the present invention are shown. The operation of the system is controlled from an operator console 12 which includes a keyboard or other input device 13, a control panel 14, and a display screen 16. The console 12 communicates through a link 18 with a separate computer system 20 that enables an operator to control the production and display of images on the display screen 16. The computer system 20 includes a number of modules which communicate with each other through a backplane 20a. These include an image processor module 22, a CPU module 24 and a memory module 26, known in the art as a frame buffer for storing image data arrays. The computer system 20 is linked to disk storage 28 and tape drive 30 for storage of image data and programs, and communicates with a separate system control 32 through a high speed serial link 34.

The system control 32 includes a set of modules connected together by a backplane 32a. These include a CPU module 36 and a pulse generator module 38 which connects to the operator console 12 through a serial link 40. It is through link 40 that the system control 32 receives commands from the operator to indicate the scan sequence that is to be performed. The pulse generator module 38 operates the system components to carry out the desired scan sequence and produces data which indicates, for RF transmit, the timing, strength and shape of the RF pulses produced, and, for RF receive, the timing and length of the data acquisition window. The pulse generator module 38 connects to a set of gradient amplifiers 42, to indicate the timing and shape of the gradient pulses that are produced during the scan. The pulse generator module 38 can also receive patient data from a physiological acquisition controller 44 that receives signals from a number of different sensors connected to the patient, such as ECG signals from electrodes attached to the patient. And finally, the pulse generator module 38 connects to a scan room interface circuit 46 which receives signals from various sensors associated with the condition of the patient and the magnet system. It is also through the scan room interface circuit 46 that a patient positioning system 48 receives commands to move the patient to the desired position for the scan.

The gradient waveforms produced by the pulse generator module 38 are applied to the gradient amplifier system 42 having Gx, Gy, and Gz amplifiers. Each gradient amplifier excites a corresponding physical gradient coil in a gradient coil assembly generally designated 50 to produce the magnetic field gradients used for spatially encoding acquired signals. The gradient coil assembly 50 and a polarizing magnet 54 form a magnet assembly 52. An RF coil assembly 56 is placed between the gradient coil assembly 50 and the imaged patient. A transceiver module 58 in the system control 32 produces pulses which are amplified by an RF amplifier 60 and coupled to the RF coil assembly 56 by a transmit/receive switch 62. The resulting signals emitted by the excited nuclei in the patient may be sensed by the same RF coil assembly 56 and coupled through the transmit/receive switch 62 to a preamplifier module 64. The amplified MR signals are demodulated, filtered, and digitized in the receiver section of the transceiver 58. The transmit/receive switch 62 is controlled by a signal from the pulse generator module 38 to electrically connect the RF amplifier 60 to the coil assembly 56 during the transmit mode and to connect the preamplifier module 64 to the coil assembly 56 during the receive mode. The transmit/receive switch 62 can also enable a separate RF coil (for example, a surface coil) to be used in either the transmit or receive mode. The transceiver module 58, the separate RF coil and/or the coil assembly 56 are commonly configured to support parallel acquisition operation.

The MR signals picked up by the separate RF coil and/or the RF coil assembly 56 are digitized by the transceiver module 58 and transferred to a memory module 66 in the system control 32. A scan is complete when an array of raw k-space data has been acquired in the memory module 66. This raw k-space data is rearranged into separate k-space data arrays for each image to be reconstructed, and each of these is input to an array processor 68 which operates to Fourier transform the data to combine MR signal data into an array of image data. This image data is conveyed through the serial link 34 to the computer system 20 where it is stored in memory, such as disk storage 28. In response to commands received from the operator console 12, this image data may be archived in long term storage, such as on the tape drive 30, or it may be further processed by the image processor 22 and conveyed to the operator console 12 and presented on the display 16.

While the above descriptions of methods and systems contain many specificities, these should not be construed as limitations on the scope of any embodiment, but as exemplifications of the presently preferred embodiments thereof. Many other ramifications and variations are possible within the teachings of the various embodiments.

What is claimed is:

1. An apparatus comprising:
a. at least one machine learning element,
b. at least one human learning element,
c. said at least one machine learning element and said at least one human learning element work jointly to process data and make inferences.
